(19) United States
(12) Patent Application Publication
(10) Pub. No.: US 2025/0124211 A1
(43) Pub. Date: Apr. 17, 2025

(54) APPARATUS FOR EDITING LAYOUT, NON-TRANSITORY COMPUTER-READABLE STORAGE MEDIUM, AND METHOD

(71) Applicant: CANON KABUSHIKI KAISHA, Tokyo (JP)

(72) Inventor: NOBUHIRO OGAWA, Chiba (JP)

(21) Appl. No.: 18/911,106

(22) Filed: Oct. 9, 2024

(30) Foreign Application Priority Data
Oct. 12, 2023 (JP) 2023-176690

(51) Int. Cl. G06F 40/106; G06T 11/00

(52) U.S. Cl. CPC G06F 40/106; G06T 11/00

(57) ABSTRACT

An apparatus for editing a layout of a document on an editing screen according to the present disclosure specifies a generation-source image to be used for generating a new image, sets prompt information in a prompt input area, causes a generative model to generate a new image using the specified generation-source image and the set prompt information, and presents the generated new image as an element to be used for editing the layout of the document on the editing screen.

### BACKGROUND

### Field

The present disclosure relates to an apparatus and method for acquiring an appropriate image when the layout of documents, such as a poster or a flyer.

### Description of the Related Art

Templates having sample texts and/or sample images laid out in advance is generally employed when documents (sheets), such as a poster and a flyer are created. When layout data of documents, such as a poster and a flyer, is to be edited through this method, a user initially selects a template closest to a final product the user has envisioned. Next, the user adjusts the overall layout of the selected template by adding and deleting design elements (hereinafter, simply referred to as elements), such as text and images, and by changing a position of the elements. In the template, a theme, a color combination, and a layout are previously set, so that the user can create a document by simply adding elements, such as images and character strings, suitable for the template. For example, in a case where the user selects a template for a business seminar, the user creates a document, such as a poster, by adding elements, such as text in a stylish font and images, suitable for a business scene in conformance to the template. A font suitable for the template can automatically be applied to a character string input by the user if a font is set in advance to a text field within the template. In contrast, unlike the font of the text, an image suitable for the template has to be prepared by the user.

According to a technique discussed in Japanese Patent Application Laid-Open No. 2017-37557, a search keyword is created by extracting a word from property information of an object included in a template. Then, an image is searched for from a separately-prepared image group using the search keyword, so that an image suitable for the template is made searchable.

### SUMMARY

According to an aspect of the present disclosure, in editing a layout of a document on an editing screen, an apparatus specifies a generation-source image to be used for generating a new image, sets prompt information in a prompt input area, causes a generative model to generate a new image using the specified generation-source image and the set prompt information, and presents, on the editing screen, the generated new image as an element to be used for editing the layout of the document.

Further features of the present disclosure will become apparent from the following description of exemplary embodiments with reference to the attached drawings.

### BRIEF DESCRIPTION OF THE DRAWINGS

FIG. 1 is a block diagram illustrating a system configuration relating to a layout data editing apparatus that edits layout data to be output through an image output apparatus 100.

FIG. 2 is a block diagram illustrating an example of a hardware configuration of the image output apparatus 100.

FIG. 3 is a block diagram illustrating an example of a hardware configuration of a client personal computer (PC) 102 and a server PC 104.

FIG. 4 is a block diagram illustrating examples of functional blocks included in a printing system for executing printing through the image output apparatus 100.

FIG. 5 is a diagram illustrating an example of a layout data database (DB).

FIG. 6 is a diagram illustrating an example of a layout data editing screen of the client PC 102.

FIG. 7 is a diagram illustrating an example of image generation processing.

FIG. 8 is a flowchart illustrating an example of processing for generating an image suitable for a template on a layout data editing screen 600.

FIG. 9 is a diagram illustrating an example of a layout data DB including prompt information.

FIG. 10 is a diagram illustrating an example of a layout data editing screen including a button for regenerating an image.

FIG. 11 is a diagram illustrating an example of prompt information generation processing.

FIG. 12 is a diagram illustrating an example of a layout data editing screen from which existing prompt information can be selected.

FIG. 13 is a diagram illustrating an example of a layout data DB including a prompt information application condition.

FIG. 14 is a flowchart illustrating an example of processing for determining whether prompt information is applicable to a specified element displayed on the layout data editing screen 600.

FIG. 15 is a diagram illustrating an example of a layout data DB including a prompt information application area.

FIG. 16 is a diagram illustrating an example of a layout data DB including prompt information post-application processing.

### DESCRIPTION OF THE EMBODIMENTS

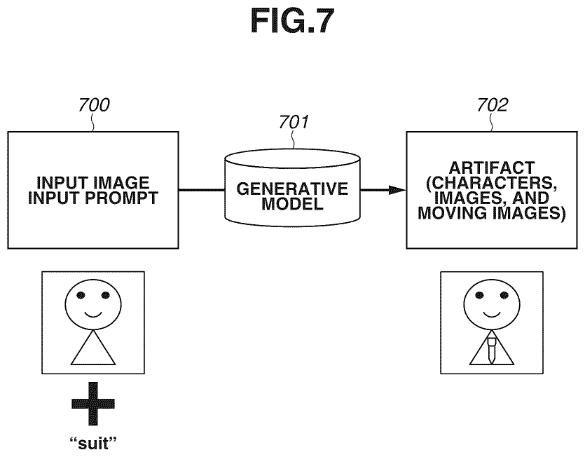

A first exemplary embodiment of the present disclosure is described. In recent years, a generative artificial intelligence (AI) technique employing generative models, such as Stable Diffusion (https://stability.ai/), Chat Generative Pre-trained Transformer (ChatGPT) (Trademark, https://chat.openai.com/), and a generative adversarial algorithm (Generative Adversarial Network (GAN)), has drawn public attention. In the generative AI technique, when an image and/or a text are/is input as an input image/input prompt 700 to a generative model 701, the generative model 701 outputs an artifact 702, such as a character, an image, and a moving image, which is highly likely to conform to the “context” expressed by the input image/input prompt 700 input to the generative model 701, as illustrated in FIG. 7. A relationship between the input value and “context” is acquired by the generative model 701 previously performing learning using a huge number of images and sentences. The artifact 702 can be changed by changing an initial value mainly generated from a random number at the time of generation. In particular, a generative model for automatically generating an image from an input image or an input prompt is also called “image generative AI”.

In the present exemplary embodiment, a description will be provided of a technique for generating an image suitable for the template with the use of an image generative AI when a document (printed material), such as a poster or a flyer, is created using a template. In the present exemplary embodiment, a poster, a flyer, and a document are collectively called “document” or “printed material”.

Initially, an information processing system according to the present exemplary embodiment is described. The information processing system according to the present exemplary embodiment is described as, as an example, a printing system that edits layout data through an information processing apparatus (client personal computer [PC]), creates a print job using the edited layout data, and outputs the print job through an image output apparatus. When a print job is to be created, print setting may be made on a screen of the information processing apparatus (client PC) as appropriate.

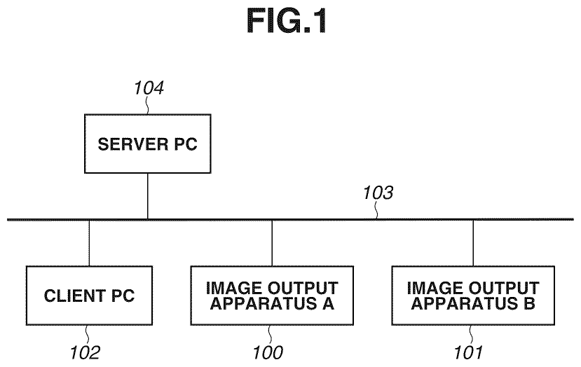

FIG. 1 is a block diagram illustrating an example of a system configuration of the system in a network environment.

As illustrated in FIG. 1, a client PC 102 is connectable to a server PC 104 and image output apparatuses 100 and 101 via a network 103. The client PC 102 executes editing operation on layout data for a space of a document, such as a poster or a flyer, according to the operation performed by the user. At this time, the client PC 102 may request the server PC 104 to execute part of processing including editing processing, data processing, and rendering processing, relating to the layout data. The client PC 102 generates a print job by applying a print setting to the layout data having been subjected to the editing operation, transmits the print job to the image output apparatus 100 (or 101), and causes the image output apparatus 100 (or 101) to print the print job, thus outputting a result. While the present exemplary embodiment includes two image output apparatuses, this is not limiting. One or more than two image output apparatuses may be included. Further, while the present exemplary embodiment includes one client PC 102 and one server PC 104, the system may include two or more client PCs and server PCs. The server PC 104 may be a virtual PC implemented by cloud computing. Any network, such as a wired local area network (LAN), a wireless LAN, the internet, or Bluetooth®, is useable as the network 103.

In the present exemplary embodiment, a description will be provided of a print implementation example in which a print job is transmitted to the image output apparatus 100 from a printing application installed in the client PC 102 via a printer driver. Here, a printing application and a printer driver are installed in the client PC 102. The printing application acquires printing parameters, such as device information about the image output apparatus 100 associated through the printer driver, a sheet type, a sheet size, and print quality, so that the printing application can edit the print settings based on the acquired parameters. The client PC 102 generates a print job based on the set print setting and a layout data image acquired as a result of rendering processing performed on the layout data. The generated print job is spooled in the printer driver and transmitted to the image output apparatus 100. The image output apparatus 100 perform printing processing based on the print setting set for the print job received from the client PC 102.

The image output apparatus 100 stores information about components as device information, such as ink and sheets, handled by the image output apparatus 100, and status information, such as an idling state or a printing error state. Further, in a case where printing is unable to normally operate due to an error in the image output apparatus 100, such as shortage of remaining sheets or ink, or an erroneous print setting, the image output apparatus 100 presents a reason to the user indicating why normal printing cannot occur by displaying a warning message on a panel on the main body.

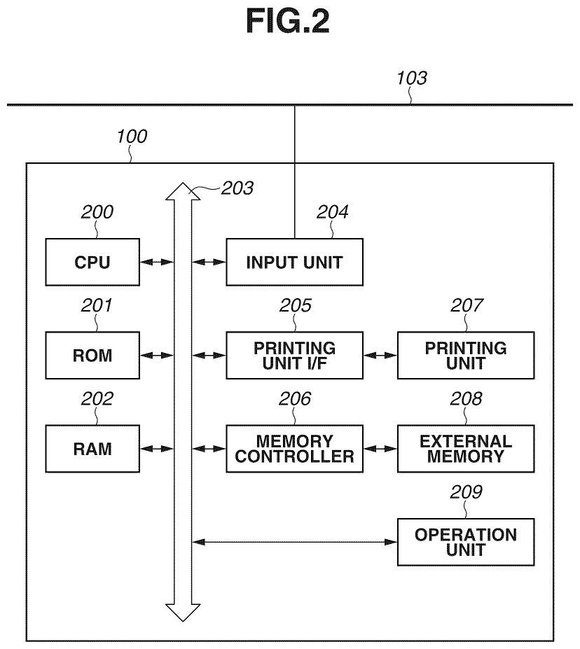

FIG. 2 is a block diagram illustrating an example of a hardware configuration of the image output apparatus 100. The image output apparatus 101 also has a similar configuration. A central processing unit (CPU) 201 controls the processing units included in the image output apparatus 100 by performing a control program stored in a program read only memory (ROM) of a ROM 201, or in an external memory 208. The CPU 200 outputs image signals as output information to a printing unit (printer engine) 207 that is connected to a printing unit interface (I/F) 205 via a system bus 203. The CPU 200 can perform communication processing with the client PC 102 via an input unit (network I/F) 204, so that the CPU 200 can provide information stored in the image output apparatus 100 to the client PC 102. The CPU 200 can receive output data to be output to the printing unit 207 via the input unit 204.

A random access memory (RAM) 202 functions as a main memory and/or a working area of the CPU 200, and the memory capacity of the RAM 202 can be expanded by an optional RAM that is connected to an expansion port (not illustrated). A memory controller 206 controls access from the external memories 208, such as a hard disk drive (HDD) or an integrated circuit (IC) card. The external memories 208 can optionally be connected, and font data, an emulation program, form data, information about used ink and a type and a size of feeding sheets, and information about a status of the main body are stored in the external memories 208. An operation unit 209 includes a display panel, and can display various types of information.

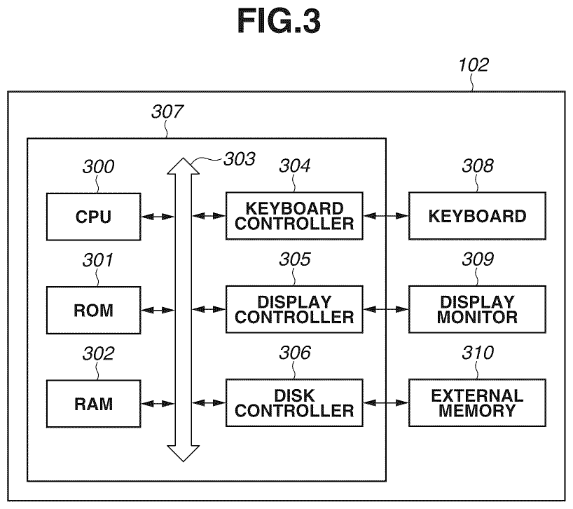

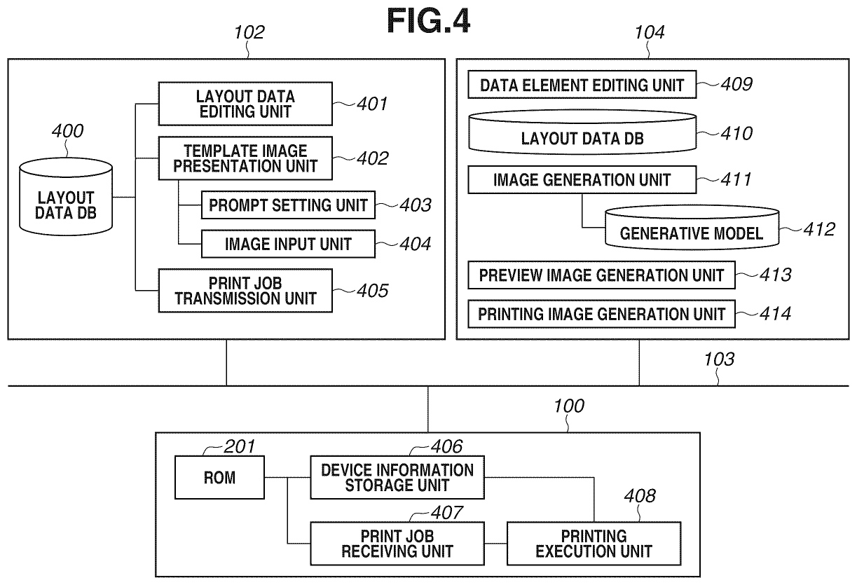

FIG. 3 is a block diagram illustrating an example of a configuration of a computer included in each of the client PC 102 and the server PC 104 in FIG. 1. An inner portion 307 of the computer includes a CPU 300, a ROM 301, a RAM 302, a keyboard controller 304, a display controller 305, and a disk controller 306. The CPU 300 reads various programs, such as a control program, a system program, and an application program, onto the RAM 302 from an external memory 310 via the disk controller 306. The CPU 300 performs various types of data processing and display control of a display monitor 309 by performing various programs read to the RAM 302. In other words, the CPU 300 included in each of the client PC 102 and the server PC 104 functions as a processing unit for performing various functions described below in FIG. 4 by executing the programs. The CPU 300 may read the control program from the ROM 301. All or part of the processing unit implemented by the CPU 300 may be implemented by a dedicated circuit, such as an application specific integrated circuit (ASIC). The CPU 300 and the dedicated circuit are examples of a hardware processor and a hardware circuit. Access from the external memories 310, such as a hard disk (HD), a compact disc read only memory (CD-ROM), a digital versatile disc read only memory (DVD-ROM), and a universal serial bus (USB), is controlled by the disk controller 306. The RAM 302 is mainly used as a working area of the CPU 300, and the capacity of the RAM 302 can be expanded by an optional RAM (not illustrated). The keyboard controller 304 controls key input on the keyboard 308 or with a pointing device (not illustrated). The display controller 305 performs display control on the display monitor 309. In the present exemplary embodiment, unless otherwise specified, the CPU 300 controls the units connected to a main bus 303 via the main bus 303. Naturally, constituent elements which may be omitted in the server PC 104, such as the display monitor 309, do not necessarily have to be included in the constituent elements of the server PC 104. Each of the client PC 102 and the server PC 104 includes a network I/F (not illustrated), and can communicate with the other apparatuses via the network 103.

FIG. 4 is a block diagram illustrating examples of functional blocks that relate to the image output apparatus 100, the client PC 102, and the server PC 104 described in conjunction with FIGS. 1 to 3 in the system according to the present exemplary embodiment. Initially, the functional blocks of the client PC 102 and the server PC 104 are described. A layout data editing unit 401 adds and/or deletes design elements (hereinafter, simply referred to as element), such as characters and images to be put on a poster and a flyer, and adjusts the layout of the respective elements. In a case where processing, such as cutout processing or paint-out processing, is performed on the elements, the layout data editing unit 401 requests a data element editing unit 409 of the server PC 104 to perform the processing. The layout data is stored in a layout data database (DB) 400 of the client PC 102 as a cache, or stored in a layout data DB 410 of the server PC 104 for each of client PCs 102 (or for each of accounts when usage user accounts are present).

A print job transmission unit 405 creates a print job and transmits the created print job to the image output apparatus 100. When the print job is to be created, the print job transmission unit 405 requests a preview image generation unit 413 or a printing image generation unit 414 of the server PC 104 to generate a preview image or a printing image of the layout data.

A template image presentation unit 402 requests an image generation unit 411 of the server PC 104 to generate an image based on prompt information that is to be used for image generation and is set to a prompt setting unit 403, and image information set to an image input unit 404. The image generation unit 411 of the server PC 104 inputs the prompt information and image information received from the client PC 104 to a generative model 412 to generate a new image, and transmits the generated image to the client PC 102. The template image presentation unit 402 of the client PC 102 presents the new image received from the server PC 104 to the user.

Next, functional blocks included in the image output apparatus 100 are described. A ROM 201, a device information storage unit 406, a print job receiving unit 407, and a printing execution unit 408 are included in the image output apparatus 100. The print job receiving unit 407 receives a print job transmitted from the client PC 102. The printing execution unit 408 executes printing processing using the received print job. Information about a type and/or a remaining amount of ink/tonner held on the image output apparatus 100, types and sizes of registered sheets and feeding sheets, information about a status of the image output apparatus 100 main body, and/or information about a status of a print job are stored in the device information storage unit 406.

In a case where an image output apparatus 100 to be used has been determined in advance, in order to create layout data suitable for the determined image output apparatus, 100 the information in the device information storage unit 406 is obtained to store the obtained information in association with the layout data DB 400 of the client PC 102 or the layout data DB 410 of the server PC 104.

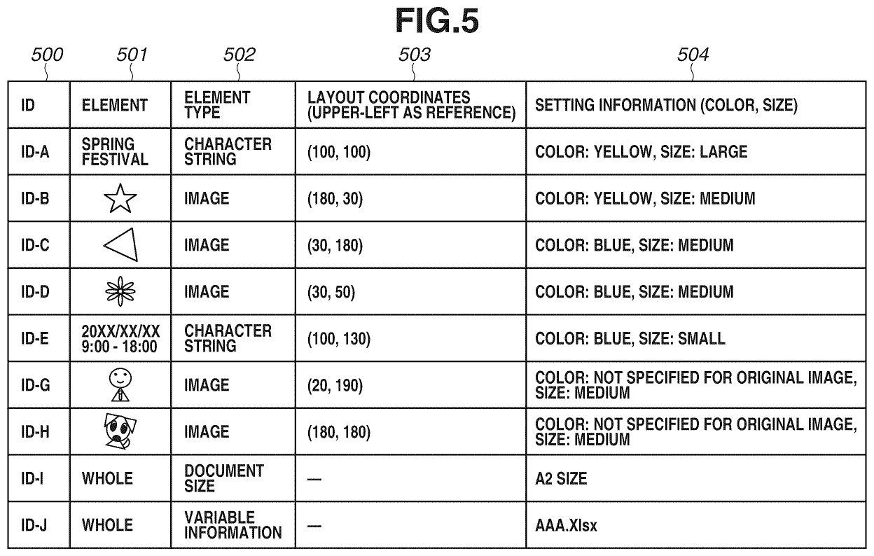

FIG. 5 is a diagram illustrating an example of layout data stored in the layout data DB 400 and/or 410. The data table illustrated in FIG. 5 is stored for the layout data of each space of sheets, such as a poster and a flyer. The data table includes parameters, such as an identifier (ID) 500 for uniquely identifying elements included in the layout data, a data element (actual data of element) 501, an element type 502, layout coordinates 503 indicating a layout position, and setting information 504 about a color and/or a size. A value of the respective elements, (actual data) such as a character and an image, laid out on the layout data is set to the element 501. Information indicating a type of the element is set to the element type 502. Values indicating an arrangement position of the element included in the layout data are set to the layout coordinates 503. Attribute values of the element, such as a color or a size of the element, are set to the setting information 504. The data table also stores settings relating to the entire layout data, such as data on a document size or data on variable printing. The information regarding these settings, “Whole” is specified in the element 501, a setting type is specified in the element type 502, and a setting value is stored in the setting information 504. Naturally, parameters may be managed based on a separate file according to a parameter type, and a parameter of a type other than the above-described types may be included in the layout data.

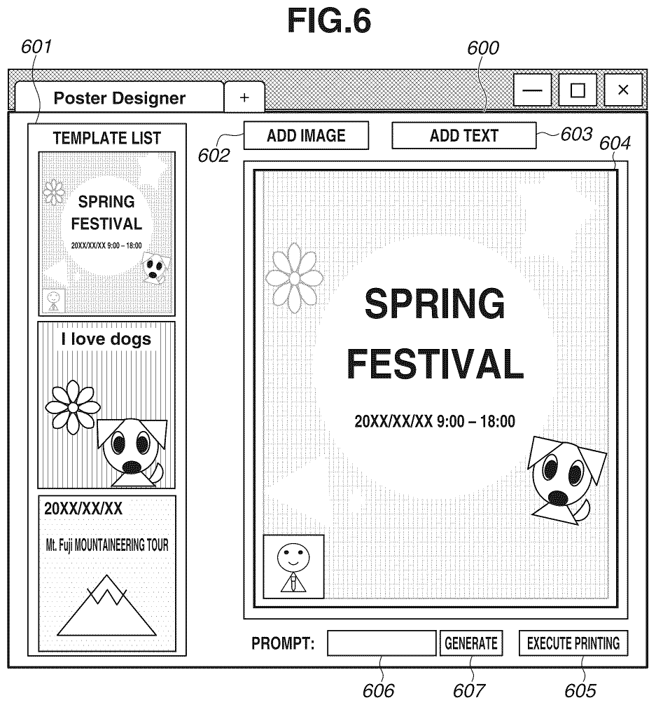

FIG. 6 is a diagram illustrating an example of a layout data editing screen 600 displayed on the display monitor 309 of the client PC 102, with the image output apparatus 100 as a target. A template list 601 displays a plurality of types of templates illustrating patters of layout data. The user selects a template closest to a final layout desired by the user and then starts editing and modifying the layout, so that time taken for the editing operation on the layout is reduced. A template selected by the user from the template list 601 is displayed on a layout editing area 604. Information about the templates displayed on the template list 601 may be acquired as layout data from the layout data DB 400 or 410, or may be fetched from an external cloud service or a social networking service (SNS).

The layout data editing unit 401 or the data element editing unit 409 performs editing processing such as positional adjustment, cutout, and paint-out processing on the respective elements displayed on the layout editing area 604 based on the user's instruction. The user presses an Add Image button 602 and an Add Text button 603 when the user would like to newly add an element, such as an image or text, to the layout editing area 604, or would like to replace an element arranged on the layout editing area 604 with another element.

For example, when the user presses the Add Image button 602, a file selection dialogue is called. When the user specifies the path of an image file, an image element is added through the processing for importing the specified image file. In a case where the user would like to replace the image element having been arranged on the layout editing area 604, the user selects the arranged image element as a replacement target, and specifies an image file as a replacement by pressing the Add Image button 602. Thus, the image element of the specified image file is arranged at a position at which the selected image element is arranged.

When the user presses the Add Text button 603, a text input dialogue is displayed on the layout data editing screen 600, so that the user can input and add desired text to the text input dialogue. The user does not always have to directly input the text. The user may specify and import a stored text file to lay out the text. In a case where the user would like to replace the text element having been arranged on the layout editing area 604, the user may perform replacement processing by pressing the Add Text button 603 after selecting the text element having been arranged thereon.

In the present exemplary embodiment, an example is described in which buttons for adding an image element and a text element are arranged. However, buttons for adding other types of elements (e.g., a graph and a table) may be arranged additionally. Further, an external cloud service storage and an SNS may be specified as import sources of elements. The processing for adding and/or replacing an image element and a text element does not always have to be performed through the operation performed on the buttons 602 and 603. For example, an element may be added or replaced when the user drags and drops an element file into the layout editing area 604.

When the user presses an Execute Printing button 605 after ending the editing operation on the layout, the print job transmission unit 405 is requested to create a print job for the layout data displayed on the layout editing area 604 and to transmit the print job to the image output apparatus 100 or 101.

It is desirable that an image to be added to the layout editing area 604 or an image to be replaced with the image currently being displayed on the layout editing area 604 be an image desired by the user, which suits the taste and atmosphere of the template of the layout data. However, the image added or used for a replacement is not always a desirable image. Further, an image included in the template data does not always completely conform to the image desired by the user. Thus, in the present exemplary embodiment, based on the image selected by the user from among the images arranged on the layout editing area 604 as well as the prompt information input to the prompt input area 606, a new image can be generated and the generated image can be provided to the user.

More specifically, the prompt information input to the prompt input area 606 is set to the prompt setting unit 403, and an image selected by the user from among the images arranged on the layout editing area 604 (or an image added using the Add Image button 602) is set to the image input unit 404. When the user presses a Generate button 607, the template image presentation unit 402 transmits the prompt information set to the prompt setting unit 403 and the image information set to the image input unit 404 to the server PC 104, and requests the server PC 104 to generate a new image. The template image presentation unit 402 receives the new image generated by the image generation unit 411 of the server PC 104 based on the prompt information and the image information, and presents the received new image to the user. In the above-described example, the processing for generating a new image is performed when the user presses the Generate button 607 after specifying the image element and inputting the prompt information. However, this configuration is not restrictive. For example, in a case where the user specifies the image element after checking the prompt information input to the prompt input area 606, the processing for generating a new image may be performed using the prompt information and the image element even if the user does not press the Generate button 607.

The user may be allowed to select an image element to be set to the image input unit 404 from among the image elements arranged on the layout editing area 604 by clicking a mouse on desired image element or by tapping the desired image element on the screen. Further, the user may be allowed to collectively specify all or a plurality of image elements displayed on the layout editing area 604. When the user selects an image element (image file) by pressing the Add Image button 602, the user is prompted to select whether to directly add the selected image element to the layout editing area 604 or to set the selected image element as an image to be input to the generative model 412. In such a case, when the user selects the image element as an image to be input to the generative model 412, the selected image element is set to the image input unit 404. Thereafter, the image element is transmitted to the server PC 104, so that a new image is generated by the generative model 412.

In a case where an image element having been arranged on the layout editing area 604 is specified as a replacement target, a new image generated based on the prompt information and the image information is presented by replacing the specified image element with the new image. Alternatively, the generated new image may be presented as a replacement candidate image, and the user is prompted to select whether to perform replacement processing with the candidate image adopted. In a case where the user specifies the image element selected with the Add Image button 602 as an image to be input to the generative model 412 and issues an instruction to simply add the image to the layout editing area 604, the generated new image may be presented by adding the generated new image to the layout editing area 604. In a case where the user specifies the image element selected with the Add Image button 602 as an image to be input to the generative model 412 and issues an instruction to replace an existing element arranged on the layout editing area 604 with the specified image element, the new image may be presented by replacing the existing element with the generated new image. Alternatively, the generated new image may be presented as a replacement candidate image, and the user is prompted to select whether to perform replacement processing using the candidate image.

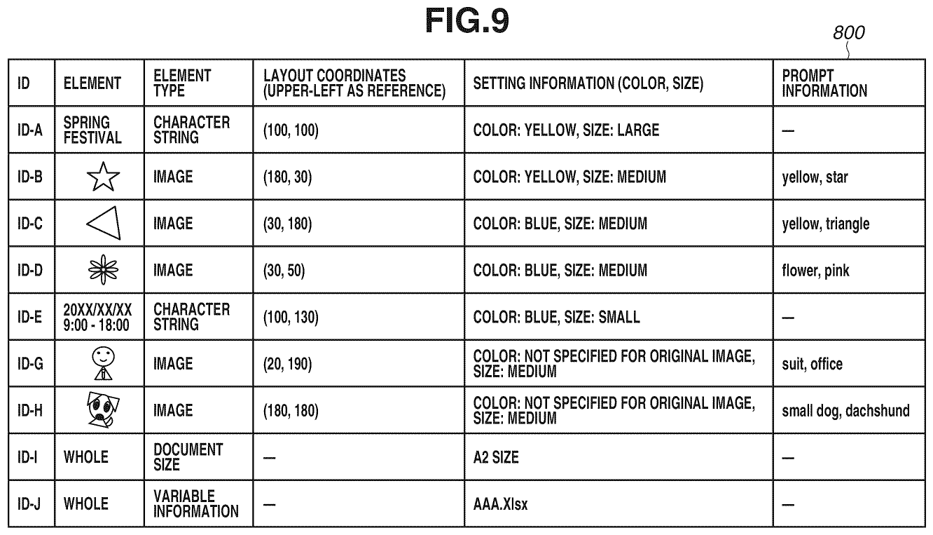

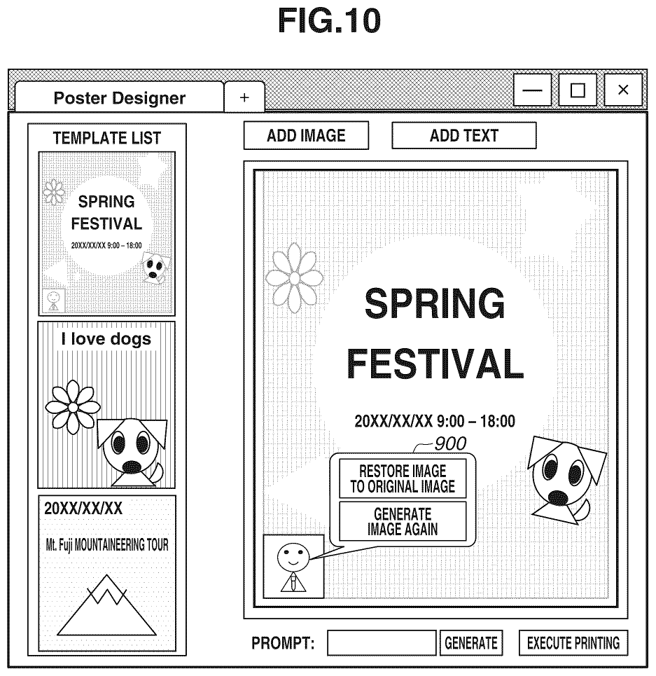

As illustrated in FIG. 9, the prompt information used for a new image generation may be stored in the layout data DB 400 and/or 410 in association with the new image element. With respect to elements included in the template in advance, a creator of the template may previously store prompt information suitable for the template in association with the elements. In such a case, when the user selects an element displayed on the layout data editing screen 600, the prompt information in association with the selected element may be called, and automatically input and displayed on the prompt input area 606. In this way, the prompt information used for generation of a new image can be called and reused for generation of another new image, and the prompt information that suits the taste of the template can be called and used for generation of an image suitable for the template. The prompt information can be reused through a method other than a method for displaying the prompt information on the prompt input area 606. For example, as illustrated in FIG. 10, the user clicks a right mouse button on the image element arranged on the layout editing area 604 to display a tool tip 900. Then, in response to a Generate Image Again button displayed on the tool tip 900 being selected, with an operation using the prompt information in association with the right-clicked image element, the user can implement the processing to be performed after pressing the Generate button 607 again using the same prompt information. Further, the image may be brought back to the original image before the new image is generated.

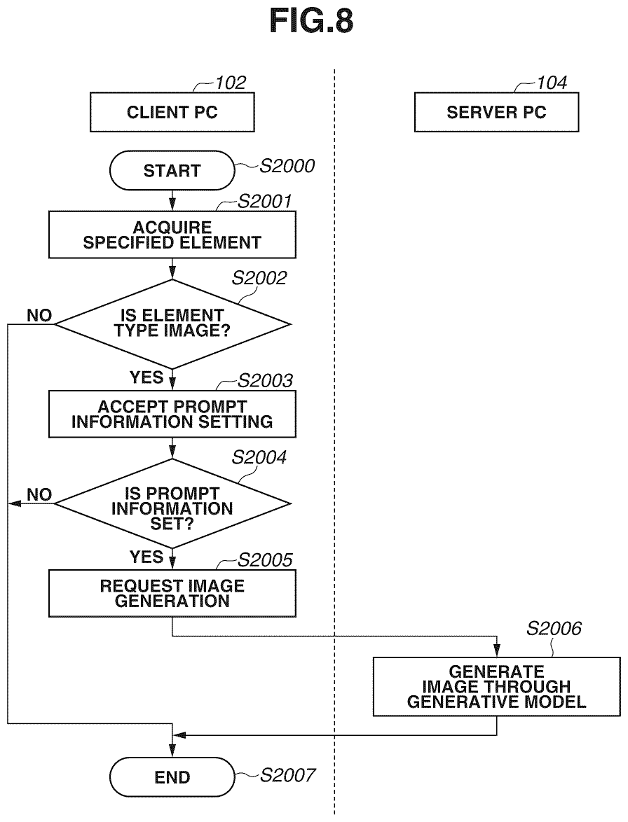

FIG. 8 is a flowchart illustrating an example of image generation processing in which, when the processing is started in step S2000, the user specifies a target image element and inputs prompt information on the layout data editing screen 600, and the information about the target image element and the prompt information are transmitted to the generative model 412 of the server PC 104 to make the generative model 412 generate an image. In the flowchart illustrated in FIG. 8, for example, the processing performed by the client PC 102 is implemented by the CPU 300 of the client PC 102 reading a program for the client PC 102 stored in the ROM 301 to the RAM 302 and executing the program. The program for the client PC 102 may be an application installed in advance in the client PC 102 or a web application. In a case where the processing is implemented by the web application, the CPU 300 executes the web application by accessing a uniform resource locator (URL) of the server PC 104 from a web browser of the client PC 102.

In step S2001, for example, the user selects an image element having been laid out on the layout data editing screen 600, and specifies the selected image element as target data (generation-source image) used for generating an image. Then, the template image presentation unit 402 sets the ID 500 indicating the specified image element to the image input unit 404. At this time, in a case where prompt information is in association with the specified image element as illustrated in FIG. 9, the prompt information in association is called and displayed on the prompt input area 606. In a case where the prompt information is not in association with the image element, prompt information is not displayed on the prompt input area 606. The prompt information displayed on the prompt input area 606 can be edited (adding, deleting, modifying a prompt, and the like) based on the user's instruction.

In step S2002, the image input unit 404 determines whether an element type 502 corresponding to the specified ID 500 is “Image”. In a case where the element type 502 is not “Image” (NO in step S2002), the processing is ended. In a case where the element type 502 is “Image” (YES in step S2002), the processing proceeds to step S2003.

In step S2003, the user inputs and edits prompt information in the prompt input area 606. In a case where the prompt information is input and edited in the prompt input area 606, the template image presentation unit 402 sets the prompt information to the prompt setting unit 403.

When the user presses the Generate button 607 after inputting and editing the prompt information, in step S2004, the client PC 102 determines whether the prompt information is set to the prompt setting unit 403. In a case where the prompt information is not set, (i.e., the prompt information is not input to the prompt input area 606) (NO in step S2004), the processing is ended in step S2007. In a case where the prompt information is set to the prompt setting unit 403 (YES in step S2004), the processing proceeds to step S2005.

In step S2005, the template image presentation unit 402 requests the image generation unit 411 of the server PC 104 to generate a new image based on the prompt information set to the prompt setting unit 403 and the image information set to the image input unit 404.

In step S2006, the image generation unit 411 of the server PC 104 generates a new image by inputting the received prompt information and the image information to the generative model 412. The server PC 104 then transmits the generated new image to the template image presentation unit 402 of the client PC 102.

The client PC 102 presents the new image transmitted from the server PC 104 to the user.

In the above-described example, in step S2001, the laid-out image element is specified as the target data (generation-source image) used for generating an image. However, the processing can similarly be performed in a case where the laid-out image element is to be replaced with an image in another image file selected from the file selection dialogue. For example, in a case where the user selects an element having been laid out on the layout data editing screen 600 as a replacement target, and also selects another image file from the file selection dialogue by pressing the Add Image button 602, the image file selected from the file selection dialogue may be treated as the target data (generation-source image) used for generating a new image. In this case, prompt information in association with the laid-out image element selected as a replacement target may be displayed on the prompt input area 606 at the time when the laid-out element is selected as a replacement target. It is assumed that the element corresponding to the ID-G in FIG. 9 is a portrait image (sample image) of a person included in a template. It is also assumed that a creator of the template associates prompt information “suit, office” with the element because the creator thinks that it is desirable to arrange a portrait image of a person dressed in a business suit in this position. In a case where the user selects the element of the portrait image as a replacement target, the prompt information “suit, office” is automatically called and displayed on the prompt input area 606. When the user selects another image file (another portrait image) as a replacement image via the file selection dialogue and requests generation of an image by using the other selected image file as a generation-source image, the user can use the prompt information displayed on the prompt input area 606 without change. For example, even if a person in a portrait image selected via the file selection dialogue is not in a business suit, the prompt information “suite, office” is transmitted to the server PC 104 together with the selected portrait image (generation-source image). In such a case, because the generative model 412 of the server PC 104 receives the prompt information “suite, office” together with that portrait image, the generative model 412 performs image processing on the portrait image so that the person in a business suit appears, thus generating a new image. Accordingly, even if the user selects a portrait image of a person not in a business suit via the file selection dialogue, a new image that is generated by the person being changed to wear a business suit suitable for the template can be provided to the user.

As described above, according to the present exemplary embodiment, even if an image suitable for the template is not prepared in advance, the user can generate a suitable image by inputting an image selected as a processing target and prompt information input to the prompt input area 606 to the generative model 412. In a case where prompt information is in association with the element included in the template in advance, it is possible to easily acquire an image suitable for the template because the prompt information can easily be called and used.

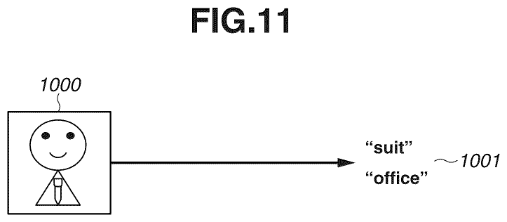

In the above-described first exemplary embodiment, as illustrated in FIG. 9, a creator of the template of layout data previously associates prompt information with image element. Thus, the associated prompt information is called when the image element is selected. In a second exemplary embodiment, as illustrated in FIG. 5, prompt information is not previously associated with any elements laid out on a template. Thus, in the present exemplary embodiment, information about a feature and a type of an object included in an image element is extracted by analyzing the details of the image element, and the extracted information is used as the prompt information. A known technique such as Segment Anything Model (SAM) (https://github.com/facebookresearch/segment-anything) or Amazon (Trademark) Rekognition (https://aws.amazon.com/jp/rekognition/) can be used as a method for extracting the information about a feature and a type of the object included in the image. For example, in a case where an image 1000 in FIG. 11 is a portrait of a person wearing a suit, prompt information 1001, “suit” and “office”, can be acquired when the image is analyzed as a prompt generation-source image.

A description will be provided of a case where the user selects an existing element displayed on the layout editing area 604 as a replacement target and specifies an image file selected from the file selection dialogue by pressing the Add Image button 602 as an image used for image generation. In this case, as illustrated in FIG. 11, the prompt information 1001 is obtained by analyzing the details of the existing element selected as a replacement target. Then, the obtained prompt information 1001 and the image file selected from the file selection dialogue are transmitted to the server PC 104 to cause the generative model 412 to generate an image.

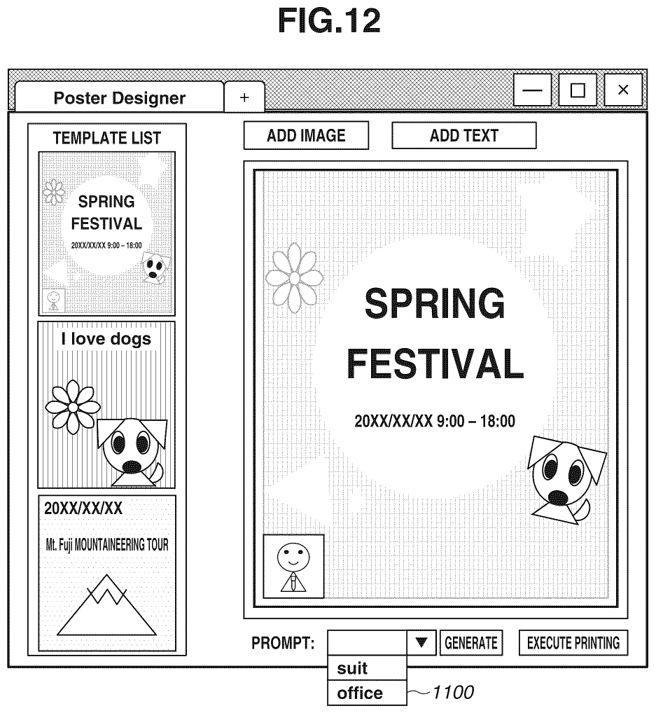

Application of index information extracted from an image laid out on the layout editing area 604 is not limited to the above-described application of the information to the image used for image generation, and the index information may simply be reused by being called out to an index input area. For example, as illustrated in FIG. 12, a prompt information selection combo box 1100 may be displayed in a case where the user selects image element corresponding to ID-G in FIG. 5 from a layout editing area. The prompt information acquired by analyzing the specified image element corresponding to ID-G may be displayed on the prompt information selection combo box 1100, so that the user can reuse the prompt information.

Naturally, the prompt information input by the user may be received as described in the first exemplary embodiment, or the user may select a plurality of pieces of prompt information from the prompt information selection combo box 1100. Prompt information to be displayed on the prompt information selection combo box 1100 may be the one used when a new image for specified element is generated at the last time or earlier. For example, history information about prompt information used in the past may be stored in the prompt information 800 in FIG. 9. This enables the user to select prompt information that has been used in the past from the prompt information selection combo box 1100 when the user performs editing operation on the layout data editing screen 600 next time. Further, in a case where information stored in the device information storage unit 406 of the image output apparatus 100 is stored in association with the layout data DB 400 or 410 in the client PC 102 or the server PC 104, prompt information suitable for the image output apparatus 100, such as “Monochrome” or “A2 size”, may be generated.

In the above-described first exemplary embodiment, the prompt information previously associated with the image element corresponding to ID-G in FIG. 9 is called and input to the generative model 412 together with the image file for image generation selected from the file selection dialogue. However, the prompt information is associated in advance with the image element corresponding to ID-G in FIG. 9 based on the assumption that the prompt information is input to the generative model 412 together with a portrait image file. In other words, the prompt information is not assumed to be input to the generative model 412 together with image data other than portrait image data. Thus, in a third exemplary embodiment, information about conditions is associated with prompt information, and the prompt information can be used when the conditions in the information are satisfied, and the prompt information cannot be used in a case where the conditions in the information are not satisfied.

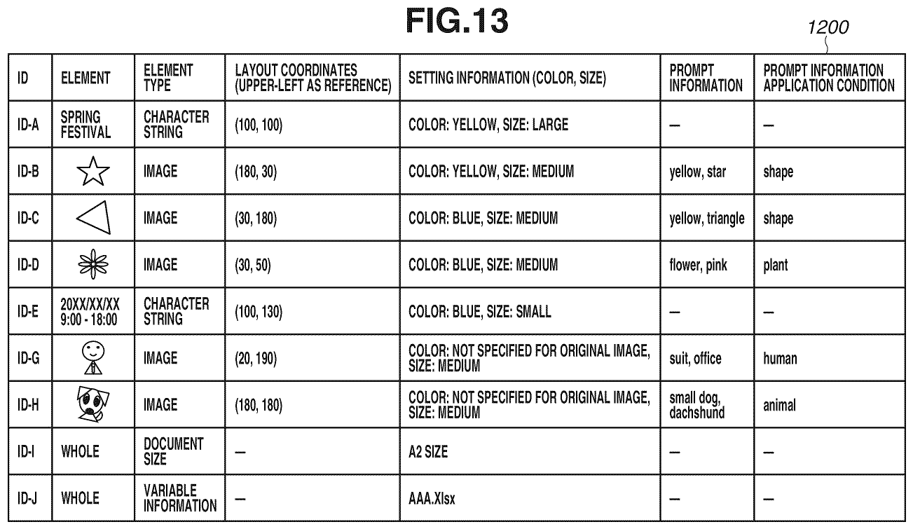

In the example illustrated in FIG. 13, a condition for determination as to whether to apply prompt information can be stored for each element in the layout data DB 400 and/or 410 as a prompt information application condition 1200. For example, in a case where the element displayed on the layout data editing screen 600 is specified by the user, the objects in the specified element are detected with the technique for detecting objects within an image, described in the second exemplary embodiment. In a case where the prompt information application condition 1200 is included in any one of the detected objects, a new image is created by using the prompt information. In a case where the prompt information application condition 1200 is not included in any of the detected objects, a new image is not created.

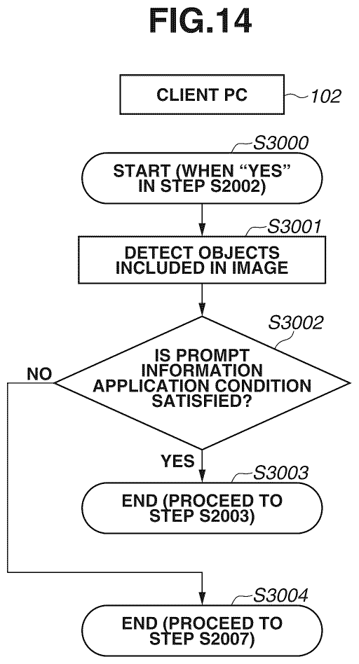

FIG. 14 is a flowchart illustrating processing for determining whether prompt information is applicable to the specified element displayed on the layout data editing screen 600. For example, the processing illustrated in the flowchart in FIG. 14 is implemented by the CPU 300 reading a program stored in the ROM 301 to the RAM 302 and performing the program. In step S3000, in a case where a result of a determination made in step S2002 in FIG. 8 indicates “YES” (YES in step S3000), the processing is started by the template image presentation unit 402 of the client PC 102 at a timing when the user presses the Generate button 607 displayed on the layout data editing screen 600. Initially, in step S3001, the template image presentation unit 402 detects objects included in the specified element set to the image input unit 404 through a technique for detecting objects in an image. Next, in step S3002, the template image presentation unit 402 determines whether an object conforming to the prompt information application condition 1200 in association with the specified element set to the image input unit 404 is included in a group of objects detected in step S3001. In a case where the template image presentation unit 402 determines that the object is included (YES in step S3002), the processing proceeds to step S2003 in FIG. 8. In a case where the template image presentation unit 402 determines that the object is not included (NO in step S3002), the processing proceeds to step S2007 in FIG. 8, and the processing is ended.

Naturally, in the object detection performed in step S3001, the template image presentation unit 402 may acquire meta information such as Exif information previously associated with the element, or may request the user to input the information when the element is specified by the user. For example, instead of the client PC 102, the image generation unit 411 of the server PC 104 or an external cloud service may be requested to perform the object detection processing in step S3001. Further, in a case where a result of determination made in step S3002 indicates “NO”, the template image presentation unit 402 may present the prompt information application condition 1200 to prompt the user to check whether to perform new image generation processing, so that the new image generation processing is performed when the user accept the execution of the processing.

A fourth exemplary embodiment of the present disclosure is now described. In the above-described first exemplary embodiment, in a case where an image suitable for the template of layout data is to be generated, an image with a change in an area where the user does not intend to change may be generated. For example, the user sets an image of a person together with prompt information as illustrated in FIG. 7 with an intention to generate a new image of a person with changed clothes. However, an image different from the user's intention, for example, different in facial expression and/or eye glasses suitable for the suit in the face, may be generated as an artifact 702.

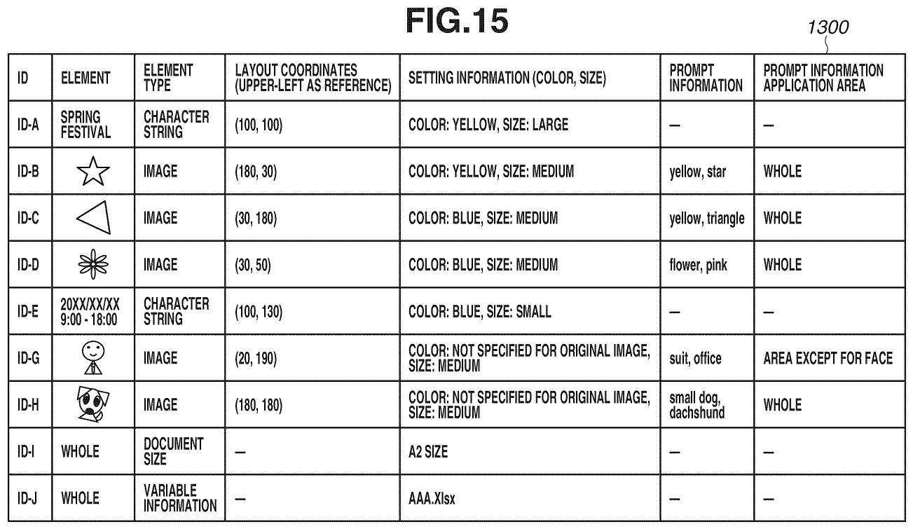

In the example illustrated in FIG. 15, information for specifying a prompt information application area is storable for each element in the layout data DB 400 and/or 410 as a prompt information application area 1300. Thus, in a case where an image added by the Add Image button 602 is specified and replaced with existing element displayed on the layout editing area 604, the prompt information application area 1300 specified for the existing element is obtained, and a new image is generated based on the obtained prompt information application area 1300 in addition to the added image and the prompt information. This enables generation of an image suitable for the template with respect to the added image without a change in the area where the user does not intend to change. Naturally, in a case where an image displayed on the layout editing area 604 is specified, or in a case where an image added with the Add Image button 602 is specified and simply added as a new image, the prompt information application area 1300 specified for the specified element is obtained, and part of the objects within the specified element can be regenerated without a change in the area where the user does not intend to change, based on the prompt information application area 1300 in addition to the specified element and the prompt information.

As specific processing, in a case where the element displayed on the layout data editing screen 600 is specified by the user, objects in the specified element are detected through the technique for detecting objects within an image, which is described in the second exemplary embodiment. Then, for the object corresponding to the prompt information application area 1300, from among the detected objects, a new image is generated using the prompt information. For example, in step S3002 of FIG. 14, the client PC 102 determines that the prompt information application condition is satisfied only when the object corresponding to the prompt information application area 1300 is present, and determines that the condition is not satisfied when the corresponding object is not present.

A fifth exemplary embodiment of the present disclosure is now described. In the above-described first exemplary embodiment, there is a case where additional processing has to be performed on a generated image in generation of an image suitable for the template of the layout data. For example, there is a possibility that a background originally included in the input image and/or a newly-generated background are/is included in the artifact 702 in FIG. 7. Further, a background of a person is unnecessary in some cases depending on layout data. In such a case, background transparency processing is to be performed using a technique such as U2-Net (https://arxiv.org/abs/2005.09007) or InSpyReNet (https://arxiv.org/abs/2209.09475). In a case where entire layout data is created in monochrome, monochrome processing is to be also performed on the artifact 702.

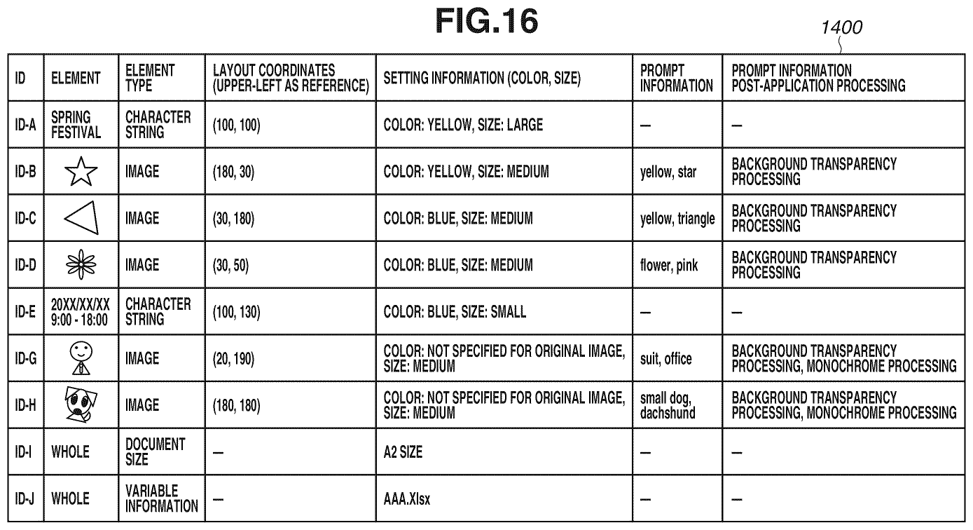

In the example illustrated in FIG. 16, post-processing to be performed on a newly-generated image after application of the prompt information can be stored for each element in the layout data DB 400 and/or 410 as a prompt information post-application processing 1400. Thus, in a case where an image added with the Add Image button 602 is specified to replace the image with an existing element displayed on the layout editing area 604, the prompt information post-application processing 1400 for the existing element is obtained, and the processing specified by the prompt information post-application processing 1400 is executed on the new image generated based on the added information and the prompt information, thus generating an image suitable for the template can be generated with respect to the added image. Naturally, in a case where an image displayed on the layout editing area 604 is specified, or in a case where an image added by the Add Image button 602 is specified and simply added as a new image, the client PC 102 acquires the prompt information post-application processing 1400 specified for the specified element, and applies the prompt information post-application processing 1400 to the image generated based on the specified element and the prompt information. In this way, it is possible to eliminate the additional processing performed by the user even in a case where a part of the objects within the specified element is regenerated.

As a specific conceivable processing, in step S2006 of FIG. 8, the image generation unit 411 of the server PC 104 refers to the layout data DB 400 or 410 and performs the processing described in the prompt information post-application processing 1400 on the generated image. Naturally, a plurality of pieces of processing may be defined as the prompt information post-application processing 1400. Further, as illustrated in FIG. 16, the pieces of processing applied to the image may be described according to the application order by separating the processing with double-quotation marks (“ ”) or a comma (,). In this way, it is possible to handle cases where it is desirable that a relationship between pre-processing and post-processing for processing such as noise reduction processing and background transparency processing be prescribed.

A sixth exemplary embodiment of the present disclosure is now described. In the first exemplary embodiment, in step S2001 of FIG. 8, a laid-out image element or an image file selected from the file selection dialogue is specified as a generation-source image used for generating an image. In some cases, a creator of a specified image element or an image file does not want the image element or the image file to be used as a generation-source image. Thus, a flag indicating whether to permit use of the image element or the image file for image generation may be set to the metadata of the image element or the image file (or the layout data DB in FIG. 9). In this case, in step S2002 of FIG. 8, the client PC 102 also determines a state of the flag set to the specified image element or the image file. Then, in a case where the flag is “TRUE”, the client PC 102 advances the processing to step S2003 and accepts a prompt setting. Further, in a case where the flag is “FALSE”, the client PC 102 may end the processing.

### Other Exemplary Embodiments

In the first exemplary embodiment, the server PC 104 includes the image generation unit 411 and the generative model 412. However, the present invention is not limited thereto. For example, the client PC 102 may include a generative model.

The present disclosure is realized by executing the following processing. Software (program) that implements the functions according to the above-described exemplary embodiments is supplied to a system or an apparatus via a network or various storage media, and a computer (or a CPU or a micro processing unit (MPU)) of the system or the apparatus reads and executes the program.

In the above-described exemplary embodiments, a layout data creation application is described as an example of the application. However, the present invention is not limited to the above-described example. The present invention has a beneficial effect, and can be realized with an optional application having a similar image layout function.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-176690, filed Oct. 12, 2023, which is hereby incorporated by reference herein in its entirety.

What is claimed is:

1. An apparatus for editing a layout of a document on an editing screen, the apparatus comprising:
at least one memory that stores instructions;
at least one processor that executes the instructions to:
specify a generation-source image to be used for generating a new image;
set prompt information in a prompt input area;
cause a generative model to generate a new image using the specified generation-source image and the set prompt information; and
present, on the editing screen, the generated new image as an element to be used for editing the layout of the document.

2. The apparatus according to claim 1, wherein the specified generation-source image is a first image element selected by the user from a set of elements arranged on a screen for editing the layout of the document.

3. The apparatus according to claim 1, wherein the specified generation-source image is a second image specified to replace a first image element selected by the user from a set of elements arranged on a screen for editing the layout of the document.

4. The apparatus according to claim 1, wherein the set prompt information can be edited based on an instruction from a user.

5. The apparatus according to claim 1, wherein the set prompt information is initially set with prompt information stored in association with an element selected by a user from a set of elements arranged on a screen for editing the layout of the documents.

6. The apparatus according to claim 3, wherein the set prompt information is initially set with prompt information stored in association with the first image element.

7. The apparatus according to claim 1, wherein the set prompt information is initially set with information extracted by analyzing an element selected by a user from a set of elements arranged on a screen for editing the layout of the document.

8. The apparatus according to claim 3, wherein the set prompt information is initially set with information extracted by analyzing the first image element.

9. The apparatus according to claim 6, wherein, execution of the stored instructions further configures the at least one processor to, in a case where the second image does not satisfy an application condition prevent the prompt information stored in association with the first image element from being initially set as the set prompt information.

10. The apparatus according to claim 1, wherein the new image is generated by the specified generation-source image, the set prompt information, and information indicating an application area for the prompt information being input to the generative model.

11. The apparatus according to claim 1, wherein execution of the stored instructions further configure the at least one processor to apply post-processing for executing additional processing on the new image generated by the generative model, and wherein the additional processing includes at least one of background transparency processing and monochrome processing.

12. The apparatus according to claim 1, wherein execution of the stored instructions further configures the at least one processor to:
determine whether a flag associated with the specified generation-source image indicates permission allowing generating the new image by using the specified generation-source image;
execute control to cause the generative model to generate the new image in a case where it is determined that the flag indicates the permission; and
execute control to prevent the generative model from generating the new image in a case where it is determined that the flag does not indicate the permission.

13. The apparatus according to claim 1, wherein the generative model is included in a server.

14. The apparatus according to claim 1, wherein the generative model is included in the apparatus.

15. The apparatus according to claim 1, wherein the document is at least any one of a poster and a flyer.

16. A non-transitory computer-readable storage medium that stores instructions, wherein the instructions cause at least one processor to:
specify a generation-source image to be used for generating a new image;
set prompt information in a prompt input area;
cause a generative model to generate a new image by using the specified generation-source image and the set prompt information; and
present the generated new image as an element to be used for editing a layout of a document on an editing screen.

17. An editing method to be performed by an apparatus configured to edit a layout of a document, the editing method comprising:
specifying a generation-source image to be used for generating a new image;
setting prompt information in a prompt input area;
executing control to cause a generative model to generate a new image by using the specified generation-source image and the set prompt information; and
presenting the generated new image as an element to be used for editing the layout of the document on an editing screen.
